(19) United States
(12) Patent Application Publication
(10) Pub. No.: US 2017/0362471 A1
(43) Pub. Date: Dec. 21, 2017

(54) ADHESIVE STRIP FOR APPLICATION TO AN OBJECT, METHOD OF MANUFACTURING SUCH AN ADHESIVE STRIP AND METHOD OF APPLYING SUCH AN ADHESIVE STRIP TO AN OBJECT

(71) Applicant: GM GLOBAL TECHNOLOGY OPERATIONS LLC, Detroit, MI (US)

(72) Inventor: Julian Paolo CIRAMI, Ruesselsheim (DE)

(73) Assignee: GM GLOBAL TECHNOLOGY OPERATIONS LLC, Detroit, MI (US)

(21) Appl. No.: 15/625,530

(22) Filed: Jun. 16, 2017

(30) Foreign Application Priority Data
Jun. 16, 2016 (DE) 102016007377.2

(51) Int. Cl. C09J 7/02; B32B 38/00; B32B 3/26; B32B 37/12

(52) U.S. Cl. CPC C09J 7/0289; B32B 37/12; B32B 38/0012; B32B 3/266; C09J 2201/128; B32B 2038/0028; C09J 2201/16; C09J 2423/046; C09J 2433/006; B32B 2405/00

(57) ABSTRACT

An adhesive strip for application to an object, more particularly for application to an object with a strongly curved and/or angled surface or an object with a large surface area is disclosed. Methods of manufacturing and applying such an adhesive strip are disclosed as well. The adhesive strip includes a carrier structure with two opposite main expansion surfaces. At least one main expansion surface has an adhesive. Formed in the carrier structure are several weakened points penetrating the carrier structure from one main expansion surface in the direction of the other main expansion surface. The carrier structure is expandable in one tangential plane of one of the main expansion surfaces.

### CROSS-REFERENCE TO RELATED APPLICATION

This application claims priority to German Patent Application No. 102016007377.2, filed Jun. 16, 2016 which is incorporated herein by reference in its entirety.

### TECHNICAL FIELD

The present disclosure pertains to an adhesive strip for application to an object, and more particularly for application to an object with a strongly curved and/or angled surface or an object with a large surface area.

### BACKGROUND

Adhesive strips, in particular an adhesive strip with two opposite adhesive surfaces are typically used when connecting objects. In the automobile industry, adhesive strips are used for fastening carpet, felts, floor coverings, seals, noise or thermal insulation mats and for adhering trims or parts of trims in the interior or on the exterior of the motor vehicle. In the interior of a motor vehicle, trim components such as carpets, felts or leather applications are connected by adhesive strips to an object, for example a part of the vehicle bodywork or to a structural element of the trim components, the base of the cargo space or the cover of the cargo space. Adhesive strips are frequently used for fastening decorative applications.

Particularly in the case of strongly curved and/or angled surfaces homogeneous application of an adhesive strip and thus homogeneous adherence of the usually typically rectangular adhesive strip to the object is only possible with difficulty or not at all. When applying the adhesive strip to curved surfaces, overlapping of the adhesive strip often occurs preventing homogeneous and flush application of the adhesive strips to the object. This can have a negative effect on the strength of the adhesive connection and the overall optical impression of the interior of the motor vehicle. For this reason, several separate adhesive strips are often applied for sticking to a curved and/or angled surface in as overlap-free and as homogeneous a manner as possible. Therefore, adhesion to such objects requires a great deal of effort and time.

Due to restricted lateral expansion of the adhesive strip, adhesion to objects with a large surface using conventional adhesive strips typically should take place in several working stages. In most cases, several individual adhesive strips are applied adjacent to each other onto the surface of the object. Therefore, adhesion to objects with a large surface area requires a great deal of effort, time and material.

DE 198 59 203 A1 discloses an adhesive strip for attaching a component, more particularly a rubber-elastic seal, to a motor vehicle. The adhesive strip has several incisions along an edge area. The incisions ensure that tensile and pressure forces along the edge the adhesive strip are reduced after fastening of the adhesive strip. Particularly when arranging the adhesive strip on a strongly curved surface these incisions can increase in size in a gap-like manner through which high tensile stresses on the outer curvature arc are prevented.

### SUMMARY

The present disclosure provides an adhesive strip for application to an object in such a way that this adhesive strip makes it possible to adhere items too difficult to cover objects, in particular objects with a strongly curved and/or angled surface as homogeneously as possible. The present disclosure is to apply a single adhesive strip to a large area as homogeneously as possible, wherein the dimensions of the surface to which the adhesive strip is to be applied are greater than the dimensions of the adhesive strip before the use thereof.

The adhesive strip according to the present disclosure includes a carrier structure with two opposite major faces or main expansion surfaces. The main expansion surfaces include an adhesive. Formed in the carrier structure are several weakened points penetrating the carrier structure from one main expansion surface in the direction of the other main expansion surface. The carrier structure is expandable in one tangential plane of one of the main expansion surfaces.

Based on the weakened points inserted into the carrier structure, the expansion behavior and the tensile behavior of the carrier structure is influenced so that elastic and/or plastic deformation of the adhesive strip in the tangential plane of one of the main expansion surfaces is possible. When applying the adhesive strip to a strongly curved and/or angled surface it is possible to strongly deform the carrier structure locally, in particular in the area of the curve and/or the angle, to expand it, through which flush and overlap-free application and adhesion of the adhesive strip to the object is possible. Through the expandability and deformability of the adhesive strip kinks and/or overlapping of the adhesive strip are avoided, so that as homogenous covering of the object with the adhesive strip as possible can take place.

Before being applied to the object the adhesive strip is expanded by a force exerted on the carrier structure and acting in a direction perpendicular to a surface normal of one of the main expansion surfaces.

It is considered advantageous if on expanding the adhesive strip in the tangential plane of one of the main expansion surfaces the carrier structure widens due to the weakened points in the tangential plane of one of the main expansion surfaces. The carrier structure in the expanded state preferably exhibits a netlike structure.

Due to the expandability in the tangential plane of one of the main expansion surfaces it is possible to apply the adhesive strip to a large area. The dimensions of the surface to which the adhesive strip is to be applied are greater than the dimensions of the adhesive strip before the expansion thereof. In this way, possible with little material use to simply and quickly cover a large area object, for example a cargo space base or a cargo space cover of a motor vehicle.

Typically, the two main expansion surfaces of the carrier material are designed as surfaces in parallel to each other. It is however also conceivable that the two main expansion surfaces have different curvatures, that one main expansion surface is flat and the other main expansion surface is concave.

In a preferred form of embodiment of the adhesive strip the carrier structure is configured with a thin wall. The two main expansion surfaces are in parallel to each other.

Regarding the adhesive, the carrier structure may already consist of a self-adhesive material, for example of an acrylate foam, so that a separate adhesive is unnecessary.

In addition to the carrier material the adhesive strip includes other components, for example an insulating or sealing material.

In an advantageous embodiment, the weakened point may be in the form of an incision and/or opening and/or mesh. Through the design of the weakened point, for example the geometry of the respective weakened point, and/or the arrangement of the weakened points in the carrier structure the tensile and expansion properties of the carrier can be adapted to the area of application of the adhesive strip. Thus, the weakened points may only be provided in a partial area of the adhesive strip to make local expansion of the adhesive strip possible.

The opening and/or mesh may have a rhombic, oval or triangular cross-section perpendicular to one of the main expansion surfaces.

The incision may be straight, curved, curved in an S-shaped, or in the form of a cross. Preferably the weakened points are identically and regularly formed in the carrier structure. It is considered particularly advantageous if a dimension of the weakened point in the non-expanded state of the carrier structure is in a range of 0.1 cm to 5 cm.

In an advantageous further development of the present disclosure the carrier structure may have a continuous marginal area preferably circumferentially surrounding an area of the carrier structure having the weakened points. Continuous in this connection means that the marginal area is integral and has no weakened points. The continuous marginal area ensures that damage to the carrier structure is avoided when applying the adhesive strip tearing. Furthermore, a continuous marginal area guarantees particularly stable application of the adhesive strip in the marginal area. Moreover, a continuous marginal area ensures that forces acting on the marginal area are transmitted as homogeneously as possible to the carrier structure through which widening of the carrier structure is particularly easily possible.

It is considered as expedient if the carrier structure includes a plastically or elastically deformable material preferably of polyethylene, of polyethylene foam and/or acrylate form. Such materials make particularly good expansion of the carrier structure possible.

In a preferred form of embodiment of the present disclosure the other main expansion surface also has an adhesive, preferably an adhesive layer. Through this it is possible to connect two objects to each other by the adhesive strip, for example a cargo space base and a carpet.

It is advantageous if the adhesive of one main expansion surface and/or the other main expansion surface on the side facing away from the carrier structure is covered by a protection structure, preferably a protective film. This is of particular advantage if the both main expansion surfaces have an adhesive. Thus, when applying the adhesive strip the carrier structure with the one main expansion surface can initially be applied to a first structure. The protective structure covers the adhesive of the other main expansion surface, through which unintentional adhesion of the other main expansion area to other objects is prevented. After the adhering the one main expansion surface to a first object, the protective structure of the adhesive of the other main expansion surface is removed and the second main expansion surface this then adhered to the second object and the two objects are thereby connected to each other.

The method of manufacturing an adhesive strip according to the present disclosure includes providing an initial adhesive strip including an initial structure with two opposite main expansion surfaces. The main expansion surfaces are integral and one main expansion surface has an adhesive. Weakening points penetrating the carrier structure from one main expansion surface are inserted in the direction of the other main expansion surface.

A commercially available adhesive tape can be used for the initial adhesive strip. For example, an acrylate-foam adhesive tape, a polyethylene adhesive tape, a polyethylene-foam adhesive tape or a polyethylene adhesive tape may be used. It is conceivable the initial adhesive strip is present in the form of a roll rolled up on an adhesive tape core.

In an advantageous further development of the method the weakened points are inserted into the initial carrier structure by a punching process. Through this the manufacturing of the adhesive strip is made possible in a particularly simple and cost-effective manner.

In a preferred form of embodiment of the method the weakened points are inserted by a punching tool. The punching tool or a component of the punching tool at times contacts the main expansion surface having the adhesive. In the contacting area, the punching tool or the component of the punching tool includes a low-friction material, preferably polytetrafluoroethylene. In this way adhesion and/or sticking of the adhesive strip to the contact area is prevented. The low-friction material can be designed as a covering for example. The component of the punching tool can, for example, involve a punching stamp, a punching blade, a matrix and/a counter support.

It is particularly advantageous if after the application of the weakened points in the initial carrier structure, punching waste and/or punched partial areas of the initial adhesive strip is/are removed from the punching tool, preferably stripped from the punching tool, by an ejection device, preferably a mechanical ejection device.

In a preferred form of embodiment of the method the punching process is repeated several times. After the punching process, the initial adhesive strip and/or the initial structure is displaced each time by a certain dimension in the longitudinal direction.

After the punching process, a partial area of the initial adhesive strip may be detached from the remainder of the initial adhesive strip.

### BRIEF DESCRIPTION OF THE DRAWINGS

The present disclosure will hereinafter be described in conjunction with the following drawing figures, wherein like numerals denote like elements.:

FIG. 1 shows a view from above of a first example of embodiment of the adhesive strip with circular openings in accordance with the arrow I in FIG. 2;

FIG. 2 shows the adhesive strip according to FIG. 1 in a view in accordance with the arrow II in FIG. 1;

FIG. 3 shows a view from above as in FIG. 1 of the adhesive strip according to FIG. 1 in an expanded state;

FIG. 4 shows a view from above of a second example of embodiment of the adhesive strip with straight incisions;

FIG. 5 shows a view from above of a third example of embodiment of the adhesive strip with cross-shaped incisions;

FIG. 6 shows a view from above of a fourth example of embodiment of the adhesive strip with triangular incisions;

FIG. 7 shows a flow chart of the method of manufacturing the adhesive strip;

FIG. 8 shows an initial adhesive strip and a punching tool with the punching tool in an open state;

FIG. 9 shows the arrangement according to FIG. 8 with the punching tool in a closed state;

FIG. 10 shows the arrangement according to FIG. 8 after the application of the weakened points;

FIG. 11 shows the arrangement according to FIG. 8 after the application of the weakened points and displacement of the initial adhesive strip along a longitudinal direction; and

FIG. 12 shows and adhesive strip during the expansion procedure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

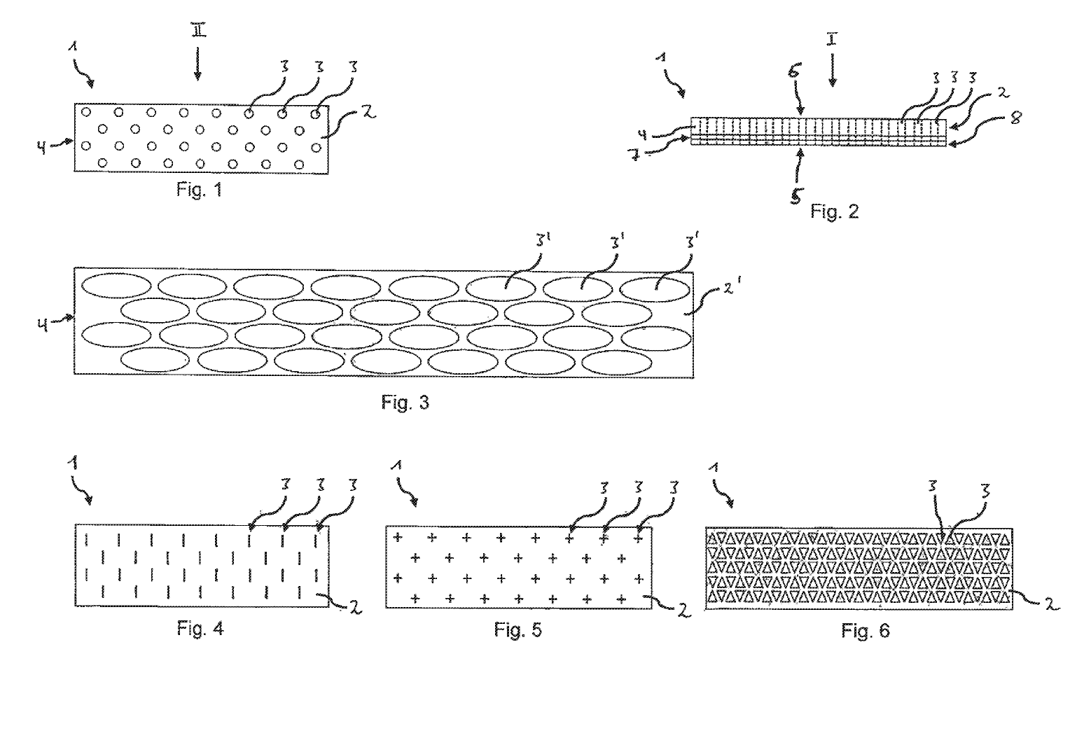

FIGS. 1 to 3 show a first example of embodiment of the adhesive strip 1, wherein the adhesive strip 1 includes a carrier structure 2 and two opposite main expansion surfaces 5, 6 extending in parallel to one another. Formed in the carrier structure 2 are several weakened points 3 penetrating the carrier structure 2 from one main expansion surface 5 in the direction of the other main expansion surface 6. The weakened points 3 are identical and are in the form of openings wherein the openings have a circular cross-section perpendicularly to the main expansion surfaces 5, 6 and are arranged regularly in the carrier structure 2. The carrier structure 2 also has a marginal area 2 surrounding the weakened points 3. This marginal area 4 is integral and thus free of weakened points 3. One main expansion surface 5 includes an adhesive 7 in the form of adhesive layer 7. The adhesive 7 is covered with a protection structure 8 on the side facing away from the carrier structure 2 and the weakened points 3 also pass through the adhesive 7 and the protection structure 8.

FIG. 3 shows the adhesive strip 1 according to FIG. 1 in an expanded state. The carrier structure 2 in the expanded state is netlike. Expansion of the adhesive strip 1 can, for example, take place in that a force is exerted in the marginal area 4 of the carrier structure 2. This force 20 acts in a direction perpendicular to a surface normal of the main expansion surfaces 5, 6.

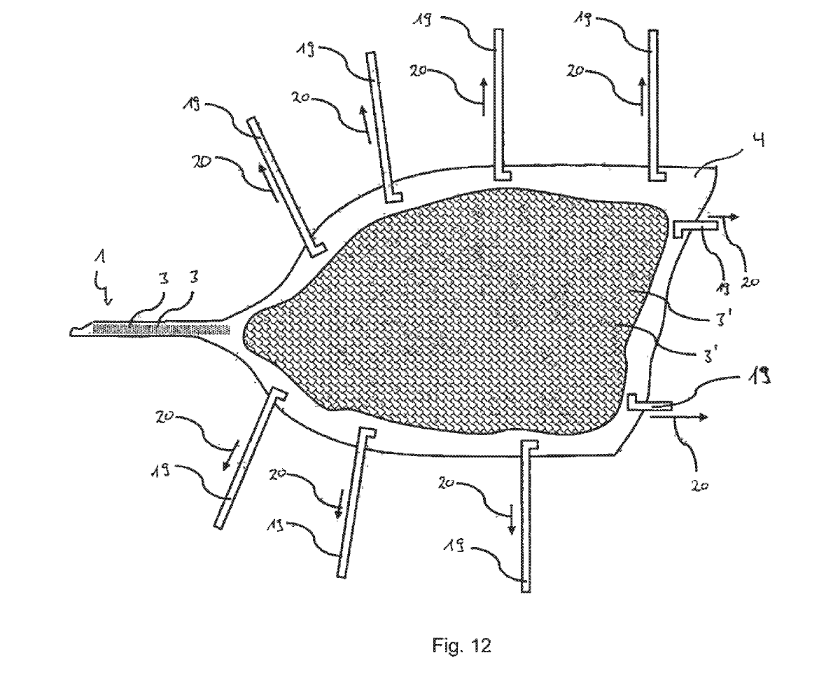

The expansion of the carrier structure 2 is shown in more detail in FIG. 12. Several hook-shaped tensioning elements 19 engage in marginal area 4 circumferentially surrounding the weakened points. The tensioning elements forces 20 acting on the tensioning elements 19 and perpendicularly to the surface normal of the main expansion surfaces 5, 6 are transmitted to the marginal area 4 and thus to the carrier structure 2, as a result of which the carrier structure 2 is stretched and expands in a netlike manner.

The weakened points 3 make expansion of the carrier structure 2 of the adhesive strip 1 possible. The proportional area of the openings 2 over the area of the main expansion surfaces 5,6 increases on expansion of the carrier structure 2. On expansion of the carrier structure 2 the dimensions of the weakened areas 3 in the form of openings and the dimensions of the carrier structure 2 in the tangential plane of the parallel main expansion surfaces increase. In FIG. 3 and FIG. 12 the expanded/enlarged weakened areas 3′ and the enlarged carrier structure 2′ are provided with corresponding apostrophized reference numbers.

After expansion and or during the expansion process, the adhesive strip 1 to be may be positioned relative to the object and/or placed on the object to which it to be adhered. Preferably positioning and/or application takes place by the tensioning element 19.

FIG. 4 shows a second example of embodiment of the adhesive strip 1. The weakened points 3 are formed as identical, straight incisions and are arranged regularly in the carrier structure 2.

A third example of embodiment of the adhesive strip 1 is shown in FIG. 5. This third embodiment differs from the second example of embodiment in that the weakened points 3 are in the form of cross-shaped incisions. The example embodiment shown in FIG. 6 includes weakened points 3 in the form of triangular openings.

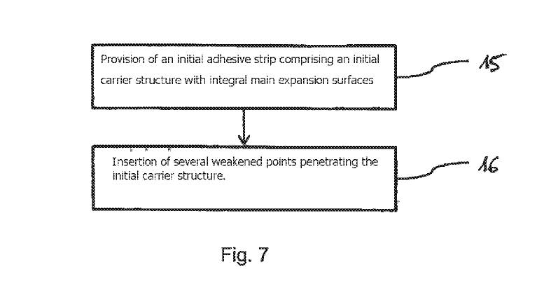

According to the flow diagram in FIG. 7 produce the adhesive strip 1 may be produced according to the present disclosure in a process in which an initial adhesive strip 9 is provided at 15 which includes an initial structure 10 with two opposite main expansion surfaces 5, 6 and one main expansion surface 5 has an adhesive 7. Next several weakened points 3 are inserted in the initial carrier structure 10 at 16 penetrating it from one main expansion surface 5 in the direction of the other main expansion surface 6.

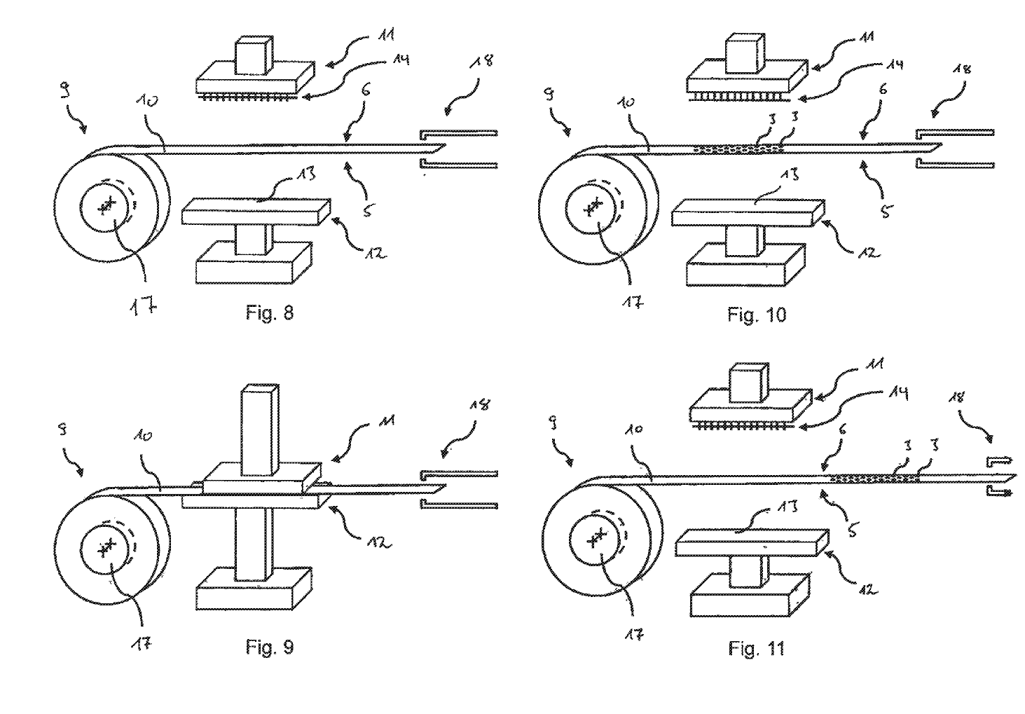

FIGS. 8 to 12 show a preferred form of embodiment of the method for producing the adhesive strip 1, wherein the weakened points 3 are inserted into the initial carrier structure 10 by a punching process. The initial adhesive strip 9 is in the form of a roll rolled up on an adhesive strip core 17.

Initially a partial area of the adhesive strip is brought into a punching zone of the punching tool 11, 12 as shown in FIG. 8. Bringing in of the partial area of the adhesive strip 1 and unrolling from the roll take place by a gripper device 18.

The punching tool 11, 12 includes a punching blade 11 and a counter support 12. The counter support 12 faces the one main expansion surface 5 and the punching blade 11 faces the other main expansion surface 6.

After arranging the initial adhesive strip 9 in the punching zone of the punching tool 11, 12, the punching blade 11 and the counter support 12 are moved towards each other whereby by the punching blade 3 the weakened areas 3 are inserted into the initial carrier structure 10. The initial structure 10 with the inserted weakened points 3 is shown in FIGS. 10 and 11.

After the insertion of the weakened points 3, the punching tool 11, 12 is moved back into the initial position and the initial adhesive strip 9 is displaced in the longitudinal direction by a determined amount.

In order to be able to detach the initial adhesive strip 9 from the punching tool 11, 12 in the best possible way, the counter support 12, in an area of contact 13 with the main expansion surface 5, is made of a low friction material, for example, polytetrafluoroethylene. In this way adherence of the adhesive 7 on the area of contact 13 with the counter support 12 is prevented. In order to remove the initial adhesive strip 9 and/or punching waste from the punching blade 11, the punching blade 11 has a mechanical ejection device 14.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. An adhesive strip for application to an object comprising a carrier structure having a first main expansion surface having a first adhesive layer formed thereon and a second main expansion surface opposite the first main expansion surface, the carrier structure having a plurality of weakened points penetrating the carrier structure from the one of the main expansion surfaces in the direction of the other main expansion surface, wherein the carrier structure is expandable in a tangential plane of one of the main expansion surfaces.

17. The adhesive strip according to claim 16, wherein the plurality of weakened points comprises one of an incision, an opening or a mesh.

18. The adhesive strip according to claim 17, wherein the opening and/or mesh are configured as a rhombic, oval or triangular cross-section perpendicular to one of the main expansion surfaces.

19. The adhesive strip according to claim 16, wherein a dimension of the plurality of the weakened points in the non-expanded state of the carrier structure is in a range of 0.1 cm to 5 cm.

20. The adhesive strip according to claim 16, wherein each of the plurality of weakened points are identically and regularly formed in the carrier structure.

21. The adhesive strip according to claim 16, wherein the carrier structure a comprises a continuous marginal area circumferentially surrounding an area of the carrier structure having the weakened points.

22. The adhesive strip according to 16, wherein the carrier structure comprises a deformable material.

23. The adhesive strip according to 16, wherein the carrier structure is a material selected from the group consisting of polyethylene foam or acrylate foam.

24. The adhesive strip according to claim 16, further comprising a second adhesive layer formed on the second main expansion surface.

25. The adhesive strip according to claim 24, further comprising a protective film covering at least one of the first or second adhesive layers.

26. A method of producing an adhesive strip having a carrier structure having a first main expansion surface having a first adhesive layer formed thereon and a second main expansion surface opposite the first main expansion surface forming an adhesive strip, the method comprising:
providing an initial carrier structure having first and second main expansion surfaces, wherein at least one of the first and second main expansion surfaces has an adhesive layer formed thereon; and
penetrating the initial carrier structure from one of the main expansion surface in the direction of the other main expansion surface to form a plurality of weakened points.

27. The method according to claim 26 further comprising inserting the weakened points into the initial carrier structure using a punching process.

28. The method according to claim 27, further comprising inserting the weakened points into the initial carrier structure using a punching tool, wherein the punching tool contacts the main expansion surface having the adhesive layer in a contacting area of the punching tool having a low-friction material.

29. The method according to claim 28, punching further comprising removing punched areas of the adhesive strip from the punching tool.

30. The method according to claim 27, further comprising displacing the adhesive strip by a given dimension in the longitudinal direction and repeating the punching process.

31. A method of applying a carrier structure having a first main expansion surface having a first adhesive layer formed thereon and a second main expansion surface opposite the first main expansion surface forming an adhesive strip, the method comprising expanding the carrier structure of the adhesive strip by applying a force to a marginal area of the carrier structure in a direction perpendicular to a surface normal of one of the main expansion surfaces and in a tangential plane of one of the main expansion surfaces.
